(19) United States
(12) Patent Application Publication
(10) Pub. No.: US 2015/0222018 A1
(43) Pub. Date: Aug. 6, 2015

(54) ANTENNA DEVICE AND ELECTRONIC APPARATUS

(71) Applicant: DEXERIALS CORPORATION, Tokyo (JP)

(72) Inventors: Tatsuo KUMURA, Tokyo (JP); Yusuke KUBO, Tokyo (JP); Hiroyuki RYOSON, Tokyo (JP)

(21) Appl. No.: 14/612,731

(22) Filed: Feb. 3, 2015

(30) Foreign Application Priority Data
Feb. 6, 2014 (JP) 2014-021529

(51) Int. Cl. H01Q 7/06; H01F 38/14; H02J 5/00

(52) U.S. Cl. CPC H01Q 7/06; H02J 5/005; H01F 38/14

(57) ABSTRACT

An invented antenna device includes a spiral coil having terminal wires extending from an inner periphery side thereof and from an outer periphery side thereof, a magnetic layer supporting the spiral coil and being formed with a cutoff portion extending from an inner periphery side thereof to an outer periphery side thereof, and a circuit board having a pair of terminal portions for connecting to the terminal wire and a connecting terminal for connecting an external circuit. The circuit board is placed in the cutoff portion, and the terminal wire extending from the inner periphery side of the spiral coil is coupled to the terminal portion located on an inner periphery side of the circuit board whereas the terminal wire extending from the outer periphery side of the spiral coil is coupled to the terminal portion located on an outer periphery side of the circuit board.

### CROSS REFERENCES TO RELATED APPLICATIONS

The present application claims priority to Japanese Priority Patent Application JP 2014-021529 filed in the Japan Patent Office on Feb. 6, 2014, the entire content of which is hereby incorporated by reference.

### BACKGROUND

1. Field of the Invention

This invention relates to an antenna device and an electronic apparatus and, more particularly, to an antenna device including a spiral coil, a magnetic layer, and a circuit board and to an electronic apparatus having such an antenna device.

2. Description of Related Art

Plural RF (Radio Frequency) antennas such as, e.g., an antenna for telephone communications, an antenna for GPS (Global Positioning System), an antenna for wireless LAN (Local Area Network)/Bluetooth (Registered Trademark), and an RFID (Radio Frequency Identifier or Identification) are mounted on recent wireless communication devices. In addition, an antenna coil for power transmission is also mounted according to increased introduction of noncontact battery charge.

As a power transmission method for a noncontact battery charge process, exemplified are such as, e.g., an electromagnetic induction method, a radio wave transmission method, and a magnetic resonance method. Each of these methods utilizes electromagnetic induction or magnetic resonance between a primary coil and a secondary coil, and the above-mentioned RFID also utilizes electromagnetic induction.

Those antennas not easily obtain targeted features when actually mounted on an electronic apparatus, even where designed to obtain the maximum features at a targeted frequency with such an antenna alone. This is because magnetic components near the antenna may interfere or couple, e.g., metal pieces located near the antenna to substantially reduce the inductance of the antenna coil and thereby to shift the resonance frequency. Such a substantial reduction of the inductance may impair receiving sensitivity.

As a measure to solve those problems, magnetic shielding members may be inserted among the antenna coil and the metal pieces located near the coil, thereby gathering magnetic flux generated from the antenna coil in the magnetic shielding members, and thereby reducing interference due to the metal pieces. Where such magnetic shielding members are disposed near the antenna coil, the inductance of the antenna coil and the coupling coefficient indicating goodness of magnetic coupling can be increased.

For antenna devices for mobile use, it is demanded to make the antenna device thin for containing the antenna device in a thin apparatus. The antenna device using a spiral coil particularly requires the coil body to be intersected with a terminal wire where the terminal wire of the coil is taken out from an inner periphery side of the coil to couple with an exterior, so that the thickness of the antenna device using the coil becomes twice of the thickness of the coil line size plus the thickness of the magnetic shielding member.

Japanese Patent Application Publication No. 2008-210861, as shown in FIGS. 5A, 5B, describes a method in which a slit 106 is formed in a magnetic shielding sheet, or namely herein simply referred to as a magnetic layer 105, for flux convergence to make thin the thickness of the antenna device, and in which a terminal wire 103a extending from an inner periphery side of a spiral coil 102 is passed through the slit, thereby making the thickness of the antenna device thinner. In this case, the thickness of the antenna device becomes either thicker one of the twice of the thickness of the spiral coil or the summation of the spiral coil 102, the magnetic layer 105, and an adhesive layer 104.

Where used for non-contact power supply, the antenna device generates more Joule heat from the coil resistance as the amount of transmission power increases, thereby increasing the temperature of the antenna device. To reduce this temperature increasing, it is required to make the line size of the coil larger or to make the cross-sectional area of the wire larger to suppress the heat generation of the coil. Under “Qi standard” as one of standards of noncontact power supply, power transmission up to 5 W is defined. Standardization corresponding up to 15 W is currently prepared, and it is becoming more important to suppress heat generation by enlarging the wire size of the coil in future.

With the method disclosed in the Publication No. 2008-210861, if the wire size of the spiral coil 102 exceeds the summation of the thicknesses of the magnetic layer 105 and the adhesive layer 104, the thickness of the antenna device comes down to the twice of the wire size, so that the antenna device cannot suppresses its thickness.

That is, with the art disclosed in Publication No. 2008-210861, a coil attaching a magnetic shielding sheet in which a coil is coupled to a magnetic shielding sheet is used, where the magnetic shielding sheet is formed with a slit for containing a wire extending from an inner periphery side of the coil. If the wire size of the coil becomes larger than the thickness of the magnetic shielding sheet, the device thickness cannot be reduced more than the twice of the wire size.

Japanese Patent Application Publication No. 2007-281315 discloses a coil component in which one terminal on a side of a spiral center of a plain spiral wire formed on an insulation layer is coupled to an extension line formed on the insulation layer and in which the plain spiral wire is accumulated. It is also disclosed that this coil component may be produced with a multilayered flexible board accumulated by pasting thin films such as, e.g., polyimide films, formed with electrode patterns. The coil component disclosed in the Publication No. 2007-281315, however, is a coil component having a different feature from that of the noncontact power supply antenna, and not targeting thinner structure.

It is an object of the invention to provide an antenna device made in a thinner size even for large power transmission capacity.

### SUMMARY

To solve the above problems, an antenna device according to a first aspect of the invention comprises a spiral coil having a pair of terminal wires extending from an inner periphery side thereof and from an outer periphery side thereof, a magnetic layer supporting the spiral coil, the magnetic layer being formed with a cutoff portion extending from an inner periphery side thereof to an outer periphery side thereof, and a circuit board having a pair of terminal portions for connecting to the terminal wire of the spiral coil and a connecting terminal for connecting an external circuit, wherein the circuit board is placed in the cutoff portion, and wherein the terminal wire extending from the inner periphery side of the spiral coil is coupled to the terminal portion located on an inner periphery side of the circuit board whereas the terminal wire extending from the outer periphery side of the spiral coil is coupled to the terminal portion located on an outer periphery side of the circuit board.

According to the antenna device, the cutoff portion is formed in the magnetic layer, and the circuit board thinner than the wire size of the spiral coil is set in the cutoff portion. The antenna device can be made in a thinner size by taking out signals through the circuit board.

These and other objects, features, aspects and advantages of the present invention will become apparent to those skilled in the art from the following detailed description, which, taken in conjunction with the annexed drawings, discloses a preferred embodiment of the present invention.

Additional features and advantages are described herein, and will be apparent from the following Detailed Description and the figures.

### BRIEF DESCRIPTION OF THE FIGURES

Referring now to the attached drawings which form a part of this original disclosure:

FIGS. 1A, 1B are a plan view and a perspective view, respectively, showing an antenna device according to a first embodiment of the invention;

FIG. 2 is an exploded perspective view showing a method for producing the antenna device shown in FIGS. 1A, 1B;

FIGS. 3A, 3B are a plan view and a perspective view, respectively, showing an antenna device according to a second embodiment of the invention;

FIG. 4 is a perspective view showing an electronic apparatus and an antenna device according to the invention; and

FIGS. 5A, 5B are a plan view and a side view, respectively, showing a prior art antenna device.

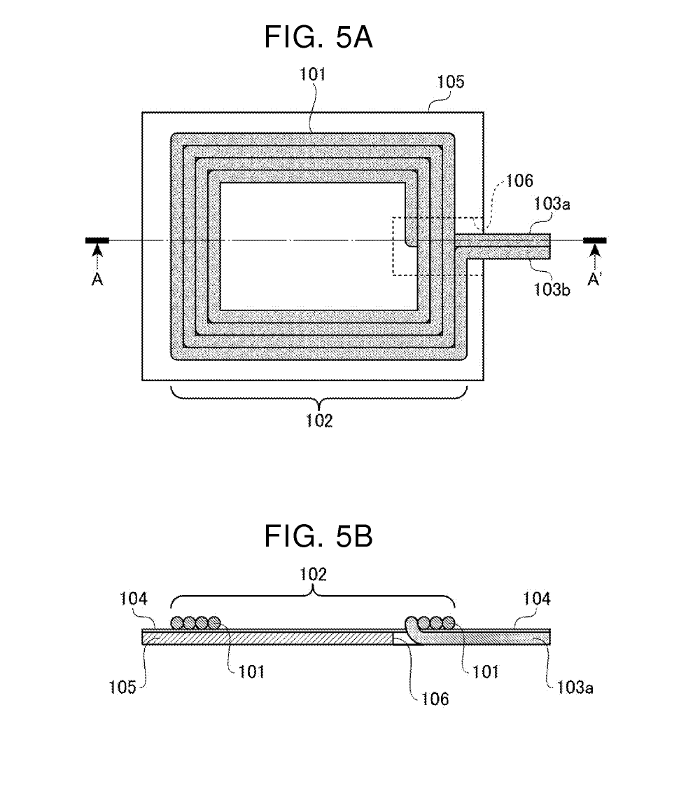

### DETAILED DESCRIPTION

Selected embodiments of the present invention will now be explained with reference to the drawings. It will be apparent to those skilled in the art from this disclosure that the following descriptions of the embodiments of the invention are provided for illustration only and not for the purpose of limiting the invention as defined by the appended claims and their equivalents.

### First Embodiment

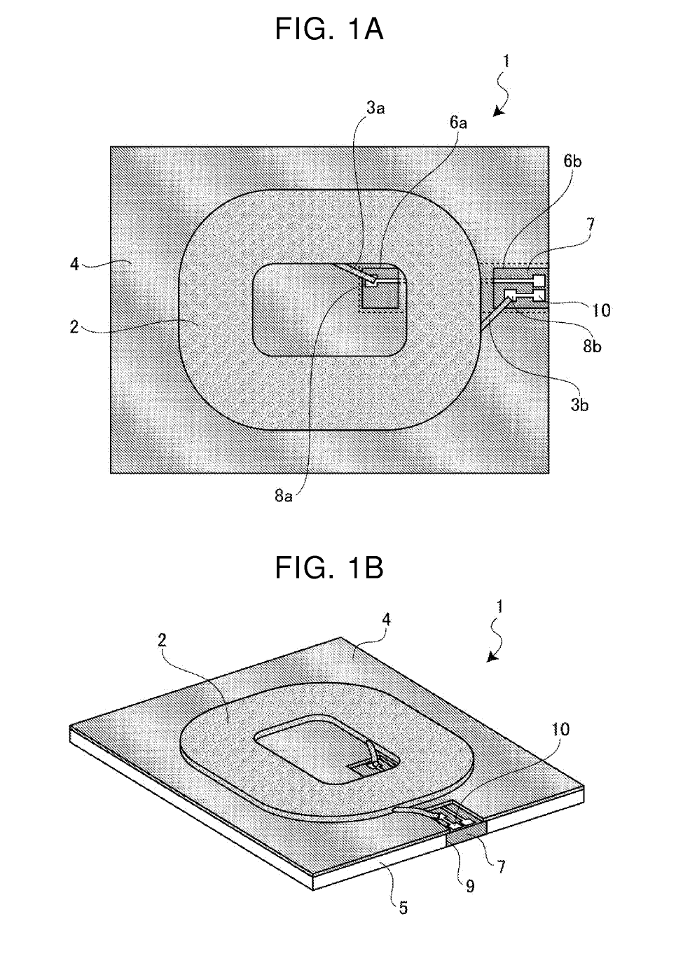

FIG. 1A is a plan view showing an antenna device according to a first embodiment of the invention, and FIG. 1B is a perspective view showing the antenna device shown in FIG. 1A for describing the structure of the antenna device.

As shown in FIGS. 1A, 1B, the antenna device 1 includes a spiral coil 2 formed by winding a conductive wire in a spiral shape, which is illustrated as large one turn for the sake of brevity, a magnetic layer 5, and a circuit board 7.

The magnetic layer 5 is formed with a cutoff portion 9, and the circuit board 7 is set in the cutoff portion 9. The spiral coil 2 is attached to the a hybrid board made of the magnetic layer 5 and the circuit board 7 via an adhesive layer 4. The cutoff portion 9 is not needed to be formed extending to an end of the magnetic layer 5 and may be formed at a portion necessary for setting the circuit board 7. The cutoff portion 9 can be formed in a shape having a groove or grooves in which the magnetic layer 5 remains partly.

The circuit board 7 is formed with terminals 8a, 8b to be connected to the terminal wires 3a, 3b of the wire constituting the spiral coil 2, connection terminals 10 connecting to an external circuit, and circuit patterns connecting the terminals 8a, 8b and the connection terminals 10 with each other. The terminal wire 3a extending from an inner periphery side of the spiral coil 2 is connected to the terminal 8a of the circuit board 7 on an inner periphery side of the spiral coil 2. The terminal wire 3b extending from an outer periphery side of the spiral coil 2 is connected to the terminal 8b of the circuit board 7 on an outer periphery side of the spiral coil 2. A secondary circuit of a noncontact charge circuit may be formed with connection of, such as, e.g., a rectifier to the connection terminals 10.

Employed as the circuit board 7 is what is formed with circuit patterns made of a conducting material on a single side or double sides of a dielectric board, or namely, a rigid board, a flexible board, and a rigid and flexible board as a hybrid body of those boards.

The magnetic layer 5 may be formed from metal magnetic bodies such as, e.g., Fe based materials, Fe-Si based materials, sendusts, permalloys, and amorphous metal materials, MnZn based ferrites, NiZn ferrites, magnetic resin materials made from adding a resin or resins as binders to magnetic particles made of one or more of the above magnetic materials, and pressurized powder molded materials made upon adding a binder in a small amount to magnetic particles. The magnetic layer 5 can be structured of a hybrid structure in combination of the plural magnetic layers made of above-mentioned materials, or an accumulated layer structure.

To the contrary, where the spiral coil 2 is used for a frequency of around 100 to 200 kHz with a charge output capacity of around 5 W, it is preferable for the wire forming the spiral coil 2 to use a single line made of Cu or an alloy having Cu as a main component in a size of 0.20 to 0.45 mm diameter. Alternatively, for the spiral coil, parallel wires or braided wires in which plural fine lines finer than the above single line are bundled can be used to reduce a skin effect of the wire, and such a spiral coil can be formed with an alpha winding structure of a single layer or double layers in use of a rectangular line or a flat line having a thin thickness,

The adhesive layer 4 is used for adhering the spiral coil 2 to one side of the hybrid board made of the magnetic layer 5 and the circuit board 7. The adhesive layer 4 can be formed of any materials having adhesive property. The adhesive layer 4 can be made from a double side adhesive tape having adhesive layers formed on double sides of a thin sheet such as, e.g., PET (polyethylene terephthalate), and further can be made of a magnetic resin sheet formed from a resin mixed with a magnetic powder or powders. When the magnetic resin sheet is used, the magnetic shielding property can be improved because the portion of the adhesive layer 4 works as a magnetic body. In this case, if the magnetic resin sheet is produced with a thicker thickness, and if the spiral coil 2 is used in an embedded way, the adhesive property and magnetic shielding property can be improved. It is also expected to gain an effect to easily escape the heat generated at the spiral coil 2.

In FIGS. 1A, 1B, not to disturb the connection between the terminal wires 3a, 3b and the interconnections on the circuit board 7 at the subsequent process, the adhesive layer 4 is formed with openings 6a, 6b at positions corresponding to the connection positions.

Thus, in the first embodiment, as shown in FIGS. 1A, 1B, the antenna device is produced by providing the circuit board 7 formed with two conductive line patterns extending from the coil inner side to the coil outer side on a back side of the spiral coil 2 for noncontact charge and by connecting the terminals on the inner periphery side and the outer periphery side of the spiral coil 2 with the conductive patterns, respectively. In a case where an increased resistance due to the reduced cross section raises a problem though the thickness is reduced from the conductive patterns on the circuit board 7, a larger pattern width may bring a solution.

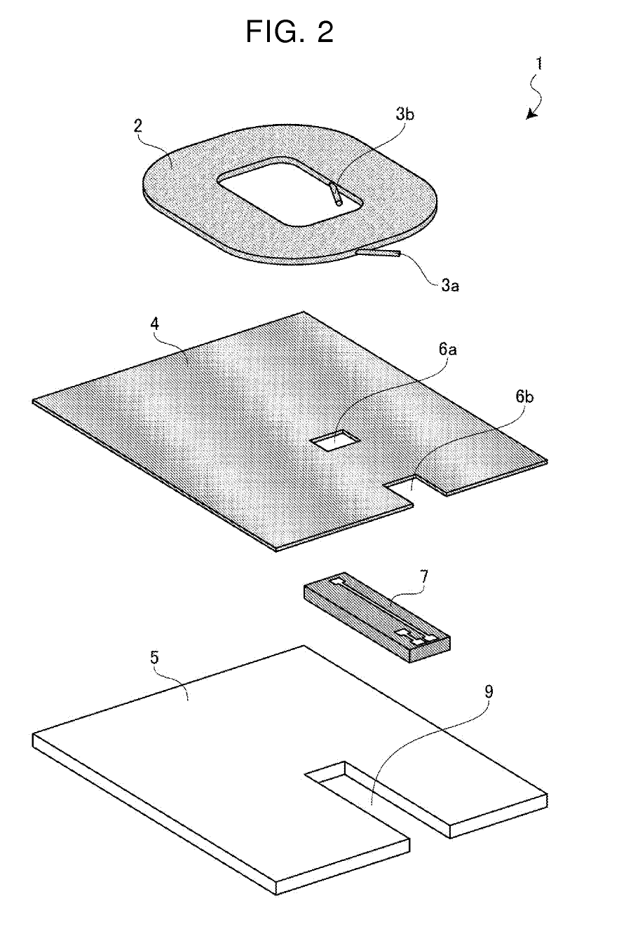

Referring to FIG. 2, an example of steps for producing the antenna device as shown in FIGS. 1A, 1B is described. FIGS. 1A, 1B are also referred properly.

First, a sheet for the magnetic layer 5 is prepared. This sheet makes the magnetic flux convergent around the spiral coil 2, and the sheet having a larger size than the size of the spiral coil 2 is selected generally. To set the circuit board 7 in the magnetic layer 5, the cutoff portion 9 in the same shape as that of the circuit board 7 is formed.

Subsequently, the circuit board 7 is inserted in the cutoff portion 9. The adhesive layer 4 is pasted on one side of the hybrid board (hybrid body) made of the magnetic layer 5 and the circuit board 7. The adhesive layer 4 is formed with the openings 6a, 6b corresponding to the terminals 8a, 8b. Those openings 6a, 6b are provided for later allowing connections between the terminal wires 3a, 3b extending from the spiral coil 2 and the conductive patterns, or namely the terminals 8a, 8b formed on the circuit board 7 with such as, e.g., a solder.

Finally, the spiral coil 2 is pasted to the surface of the adhesive layer 4 and pressed thereto. The terminal wires 3a, 3b are soldered to prescribed conductive patterns formed on the circuit board 7 (or namely, the terminals 8a, 8b in FIG. 1A) to complete the antenna device. Where a magnetic resin layer is used as the adhesive layer 4, a heating treatment may be performed at the same time as pressing to solidify the resin and secure the connection.

As described above, according to the first embodiment of the invention, the cutoff portion 9 is formed on the magnetic layer 5; the circuit board 7 is mounted in the cutoff portion 9; the terminal wire 3a on the inner periphery side of the spiral coil 2 can be connected to the coil outer periphery by means of the conductive patterns on the circuit board 7. The antenna device can be made in a thinner size, because the device can prevent the thickness from being thicker due to layer accumulation and because the device can suppress the total thickness of the device to the summation of the size of the spiral coil 2 and the magnetic layer 5, the adhesive layer 4, as well.

### Second Embodiment

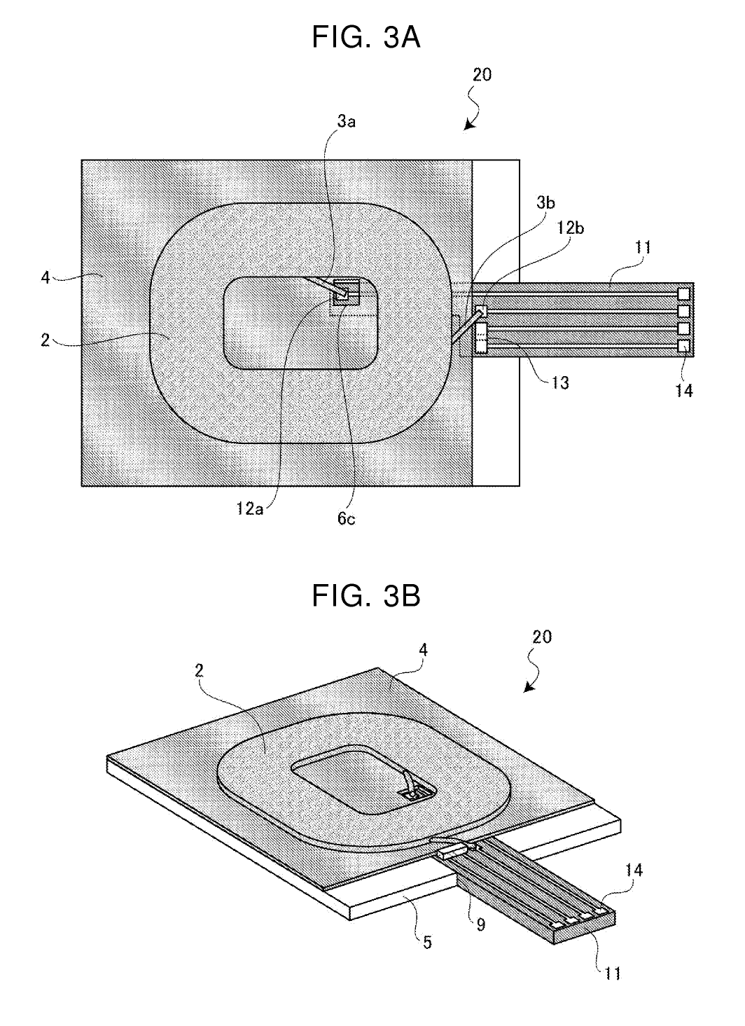

FIGS. 3A, 3B are a plan view and a perspective view showing a structure of an antenna device according to the second embodiment of the invention. For illustration purpose, elements having the same structure as those shown in the first embodiment are illustrated with the same reference numbers, and a description is omitted for the sake of brevity.

As shown in FIGS. 3A, 3B, an antenna device 20 includes the magnetic layer 5, the adhesive layer 4, the spiral coil 2, and a circuit board 11. The antenna device 20 uses a flexible cable as a circuit board. The flexible cable has a cable length longer extending outward from the magnetic layer 5 in order to make easy the connections to an external circuit or element. In this example, a sensing device 13 is mounted on the circuit board 11. The sensing device 13 may be a temperature sensing element such as, e.g., a thermistor for monitoring temperature increase and decrease of the antenna device, and a hole element for monitoring the magnetic field intense, but is not limited to those.

The circuit board 11 is formed with terminals 12a, 12b to be connected to the terminal wires 3a, 3b of the wire constituting the spiral coil 2, the connection terminals 14 connecting to an external circuit, and circuit patterns connecting the terminals 12a, 12b and the connection terminals 14 with each other. The terminal wire 3a extending from an inner periphery side of the spiral coil 2 is connected to the terminal 12a of the circuit board 11 on an inner periphery side of the spiral coil 2. The terminal wire 3b extending from an outer periphery side of the spiral coil 2 is connected to the terminal 12b of the circuit board 11 on an outer periphery side of the spiral coil 2. A secondary circuit of a noncontact charge circuit may be formed with connection of, such as, e.g., a rectifier to the connection terminals 14.

It is to be noted that in FIGS. 3A, 3B, not to disturb the connection between the terminal wire 3a and the interconnection on the circuit board 11 at the subsequent process, the adhesive layer 4 is formed with an opening 6c at a position corresponding to the connection position.

According to the second embodiment, the circuit board 11 forming the terminal interconnection is extended out of the device. By forming the circuit board made of a flexible print board, the antenna device can advantageously have an excellent mountability to the apparatus housing and have a structure readily bendable in a repeating manner at a hinge portion.

As described above, according to the second embodiment, the cutoff portion 9 is formed on the magnetic layer 5; the circuit board 11 is mounted in the cutoff portion 9; the terminal wire 3a on the inner periphery side of the spiral coil 2 can be connected to the coil outer periphery by means of the conductive pattern on the circuit board 11. The antenna device can be made in a thinner size, because the device can prevent the thickness from being thicker due to layer accumulation and because the device can suppress the total thickness of the device to the summation of the size of the spiral coil 2 and the magnetic layer 5, the adhesive layer 4, as well. The antenna device also can be provided as having a highly flexible mountability of a sensing device or devices.

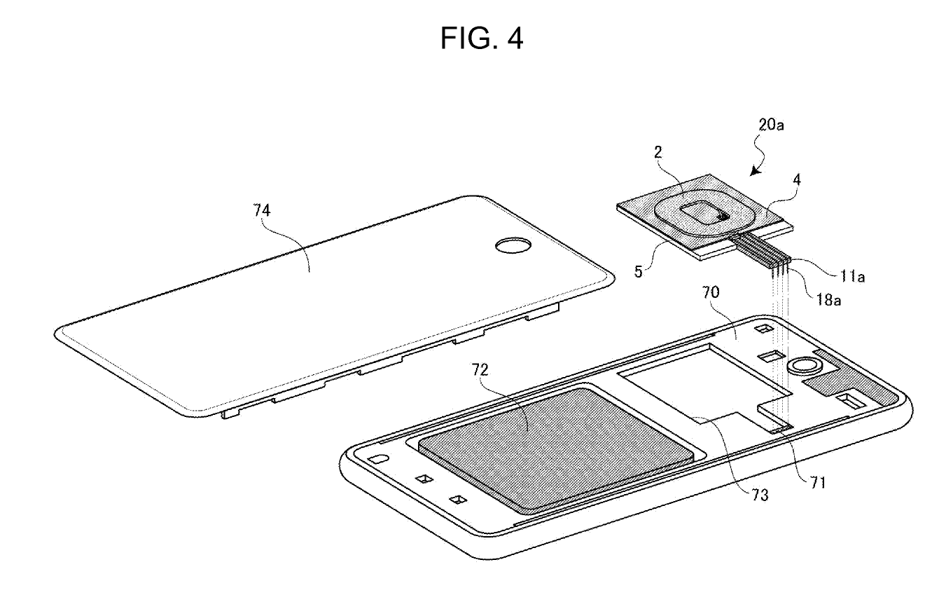

FIG. 4 shows an antenna device 20a and an electronic apparatus 70 coupled to the antenna device 20a. The antenna device 20a has a structure similar to that of the antenna device 20 mentioned above, including the spiral coil 2 formed in winding a wire in a spiral shape, the magnetic layer 5, the adhesive layer 4, and the circuit board 11a. The terminal wire 3a extending from an inner periphery side of the spiral coil 2 is connected to the terminal 12a of the circuit board 11a on an inner periphery side of the spiral coil 2. The terminal wire 3b extending from an outer periphery side of the spiral coil 2 is connected to the terminal 12b of the circuit board 11a on an outer periphery side of the spiral coil 2. The circuit board 11a has conducting patterns connected to pins 18a extending from a back side of the circuit board 11a.

The electronic apparatus 70 operates as a mobile phone and has a battery package 72 and an antenna device slot 73 to place the antenna device 20a therein. The antenna device 20a is connected to the electronic apparatus 70 via a connector 71 by inserting the pins 18a of the antenna device 20a in holes formed in the connector 71. The antenna device 20a can be placed into the antenna device slot 73 when a back cover 74 is removed from the body of the electronic apparatus 70.

In this embodiment, the electronic apparatus 70 is the mobile phone, but is applicable to other type apparatuses such as, e.g., laptop computers, and tablet devices. The connector can be made of other types such as, e.g., contact types or the like.

As described above, with the antenna device according to the first and second embodiments, the cutoff portion is formed in the magnetic layer or namely the magnetic shield layer, and the circuit board thinner than the wire constituting the spiral coil can be set to the cutoff portion. The antenna device therefore can be made in a thinner size by taking out signals sent from the inner periphery side of the spiral coil through the circuit board.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An antenna device comprising:
a spiral coil having a pair of terminal wires extending from an inner periphery side thereof and from an outer periphery side thereof;
a magnetic layer supporting the spiral coil, the magnetic layer being formed with a cutoff portion extending from an inner periphery side thereof to an outer periphery side thereof; and
a circuit board having a pair of terminal portions for connecting to the terminal wire of the spiral coil and a connecting terminal for connecting an external circuit,
wherein the circuit board is placed in the cutoff portion, and
wherein the terminal wire extending from the inner periphery side of the spiral coil is coupled to the terminal portion located on an inner periphery side of the circuit board whereas the terminal wire extending from the outer periphery side of the spiral coil is coupled to the terminal portion located on an outer periphery side of the circuit board.

2. The antenna device according to claim 1, wherein the spiral coil and the magnetic layer are adhered with a magnetic resin layer including a magnetic powder.

3. The antenna device according to claim 1, wherein the magnetic layer is made of any of a magnetic resin layer including a magnetic powder, and a pressurized powder molded layer.

4. The antenna device according to claim 1, wherein the circuit board is formed with a sensing element.

5. An electronic apparatus comprising:
the antenna device according to claim 1; and
the external circuit for performing a function of the electronic apparatus.
